(19) United States
(12) Patent Application Publication
(10) Pub. No.: US 2002/0000684 A1
(43) Pub. Date: Jan. 3, 2002

(54) Method of manufacturing three-dimensional lace material and three-dimensional lace material manufactured by the method

(75) Inventor: Noriyuki Nakanishi, Kobe-shi (JP)

Correspondence Address: Russell D. Orkin, 700 Koppers Building, 436 Seventh Avenue, Pittsburgh, PA, 15219-1818, US

(73) Assignee: SAKAE LACE CO. LTD.

(21) Appl. No.: 09/895,545

(22) Filed: Jun. 29, 2001

(30) Foreign Application Priority Data
Jun. 30, 2000 (JP) 2000-199042

(51) Int. Cl. B27N 3/10; B29C 31/00; B28B 11/08; B29C 49/08; B29C 55/00

(52) U.S. Cl. 264/257; 264/292

(57) ABSTRACT

A method of manufacturing a three-dimensional lace material is disclosed. The method includes a fabric-knitting step for knitting a planar lace fabric including an ornamental lace portion, a scallop portion continuously adjacent the ornamental lace portion and a waste-fabric portion on the opposite side to the ornamental lace portion across the scallop portion; a three-dimensional forming step for forming the planar lace fabric obtained by the material-knitting step into a predetermined three-dimensional shape by setting the fabric to a three-dimensional forming device with fixing the fabric to the device at the waste-fabric portion thereof and placing the scallop portion at an end of the three-dimensional shape to be formed; and an eliminating step for eliminating the waste-fabric portion along the scallop portion from the three-dimensional lace fabric obtained by the three-dimensional forming step, thereby to obtain the three-dimensional lace material. The invention relates also to a three-dimensional lace material manufactured by such method.

The present invention relates to a method of manufacturing a three-dimensional lace material for use in e.g. a cup surface portion of a brassier. The invention relates also to a three-dimensional lace material manufactured by the method.

### BACKGROUND OF THE INVENTION

A typical example of wardrobe product employing such three-dimensional lace material relating to the present invention is a brassier.

A cup product C for use in such a brassier, as shown in FIG. 8, often includes a lace 61 on its surface. In recent years, there is preference among consumers for a cup product C having a so-called scallop S at an upper edge thereof which comprises a continuous wave-like ornamental portion.

Referring to a specific example of such component, as shown in an exploded view in FIG. 7, the cup product includes a three-dimensionally formed urethane cup Ca, pre-determined cloths 62, 63 attached respectively to the front and back sides of the cup Ca, and a scallop lace cloth S attached to the upper edge of the cup product C as a continuous wave-like ornamental portion.

For manufacturing such cup product C as above, first, the three-dimensionally molded cup Ca is prepared and also a wide lace material prepared as a planar knitted fabric is three-dimensionally formed (specifically, molded) into a shape required by the end product. Thereafter, as illustrated in FIG. 9 (portions to be three-dimensionally formed are denoted by mark M and cutting lines are denoted by broken lines), the lace material is formed into the predetermined shape to obtain the cloth 62 as the front-side lace member. Similarly, the back-side cloth 63 is formed three-dimensionally.

Then, according to the convention, for providing the scallop lace cloth S, there is separately prepared a scallop lace material Sa.

In summary, for manufacturing a brassier by the above-described conventional method, there are prepared, as the major components thereof, the urethane cup Ca, the molded lace cloth 62, the molded back-side cloth 63 as well as the scallop lace material Sa. Then, these members are sewn together to form the cup product C having the scallop S at the predetermined edge thereof.

In manufacturing the lace cloth 62 molded in the manner described above, as a base material, there is prepared a wide lace material having a relatively large width. Then, the predetermined portions M of this material are molded. The wide lace material employed by this conventional method does not have the wave-like ornamental scallop S.

Therefore, for manufacturing the cup product C such as shown in FIG. 8, it is necessary to prepare the urethane cup Ca, the front-side lace cloth 62, the back-side cloth 63 and the scallop lace cloth Sa and then to sew these members together. Accordingly, this method is very troublesome.

Further, the use of such manufacturing method as above inevitably results in a great number of cut portions, hence, in increased waste portions to be discarded without being used.

In addition, in the finished product, as shown in FIG. 8, there are a number of sewn portions T. This leads to an appearance problem. Moreover, as each of these sewn portions T is sewn together with a tape t applied thereto, the sewn portion gives a rough surface feel to the user.

The primary object of the present invention is to solve the above-described drawbacks.

### SUMMARY OF THE INVENTION

For accomplishing the above-described object, a method of manufacturing a three-dimensional lace material, according to claim 1 of the present invention, comprises:

a fabric-knitting step for knitting a planar lace fabric including an ornamental lace portion, a scallop portion continuously adjacent the ornamental lace portion and a waste-fabric portion on the opposite side to the ornamental lace portion across the scallop portion;

a three-dimensional forming step for forming the planar lace fabric obtained by the material-knitting step into a predetermined three-dimensional shape by setting the fabric to a three-dimensional forming device with fixing the fabric to the device at the waste-fabric portion thereof and placing the scallop portion at an end of the three-dimensional shape to be formed; and

an eliminating step for eliminating the waste-fabric portion along the scallop portion from the three-dimensional lace fabric obtained by the three-dimensional forming step, thereby to obtain the three-dimensional lace material.

According to the above method, at the fabric-knitting step, there is obtained the planar lace fabric such as illustrated in FIG. 1, having the ornamental lace portion 2, the scallop portion 3 and the waste-fabric portion 4.

Then, the planar lace fabric obtained as above is subjected to the three-dimensional forming (specifically, molding) step to be formed into a predetermined three-dimensional shape. During this three-dimensional forming step is effected with placing the scallop portion at the end of the three-dimensional shape to be formed.

Moreover, in effecting the three-dimensional forming step, the waste-fabric portion of the planar lace fabric is used for fixing the fabric to the three-dimensional forming device.

With these, the three-dimensional forming step may be carried out smoothly and reliably with reliable fixing of the fabric to the forming device.

In the subsequent eliminating step, the waste-fabric portion which still remains in the three-dimensional lace fabric obtained from the three-dimensional forming step is eliminated along the scallop portion. Specifically, this eliminating step is carried out by e.g. cutting the waste-fabric portion along the scallop portion, or by pulling out an insertion thread which was inserted in advance between the scallop portion and the waste-fabric portion, thereby to separate these portions from each other, or by fusing the waste-fabric portion away from the fabric along the scallop portion.

With these steps, it is possible to obtain, from a single lace fabric, a three-dimensional lace material having a three-dimensional ornamental lace portion and a scallop portion at an end or edge of the material.

Preferably, in the manufacturing method above, according to claim 2, the planar lace fabric is an elastic lace fabric having elasticity in either a weft direction or warp direction of the fabric or elasticity in both these directions.

The lace fabric per se may be of a relatively non-elastic structure (non-elastic in the knitted structure) if the degree of the three-dimensional forming is relatively small. In the case of a relatively large degree of three-dimensional forming, however, wrinkles or even breakage may develop in the fabric during the three-dimensional forming step thereof, if the fabric is rather non-elastic.

Then, if the fabric has elasticity in either weft or warp direction or in both directions, the three-dimensional forming step may be effected without such inconvenience.

Further, as set forth in claim 3, it is also preferred that the waste-fabric portion on the opposite side to the ornamental lace portion across the scallop portion includes a fabric-fixing portion to be fixed to the three-dimensional forming device, the fabric-fixing portion having a greater strength or thickness than the remaining portion of the waste-fabric portion, the remaining portion being adjacent the scallop portion.

Namely, for the three-dimensional forming step, it is necessary to fix the planar lace fabric to the forming device. However, the waste-fabric portion generally has a rough knitted structure which tends to be insufficient in its strength, thickness etc. to be utilized for fixing the entire fabric to the forming device. Further, in the case of the present invention, the waste-fabric portion is eliminated mostly by cutting. Then, this portion should be of a structure which can be easily cut.

For the reasons above, if the waste-fabric portion includes, at a limited portion thereof, the fabric-fixing portion which has a more dense or thick construction to be suitable, in the respects of strength, thickness, etc., for the purpose of fixing, the fixing of the fabric to the forming device may be effected reliably and smoothly and the three-dimensional forming step may be carried out more satisfactorily.

With the manufacturing method and its steps described above, there is obtained a planar lace fabric for forming a three-dimensional lace material relating to claim 7, which comprises an ornamental lace portion, a scallop portion continuously adjacent the ornamental lace portion and a waste-fabric portion on the opposite side to the ornamental lace portion across the scallop portion, the waste-fabric portion including a fabric-fixing portion having a greater strength or thickness than the remaining portion of the waste-fabric portion, the remaining portion being adjacent the scallop portion.

Also, in manufacturing the three-dimensional lace material described above, as set forth in claims 4, 5, it is preferred that the ornamental lace portion includes, at a portion thereof in the immediate vicinity of the scallop portion, a scallop-reinforcing portion.

In the material of the invention, the scallop portion of the lace is disposed at the edge of the cup product to be obtained. As this scallop portion is continuous from the ornamental lace portion, the support of the scallop portion is less stiff or weaker than that provided by the conventional structure using a tape for sewing and fixing. Then, if a scallop-reinforcing portion is provided at a portion of the ornamental lace portion in the immediate vicinity of the scallop portion, such scallop-reinforcing portion may provide additional support to the scallop portion.

In the method of manufacturing a three-dimensional lace material described above, as set forth in claim 6, the method further comprises a joining step for joining a lining member (for example, the urethane cup described hereinbefore) to the three-dimensional lace material to obtain a three-dimensional lace product, with aligning the scallop portion with an end of the lining member.

With this, there is achieved a three-dimensional lace product including the lining member and the three-dimensional lace material joined together with the scallop portion of the latter being aligned with the end of the former.

As the planar lace fabric for forming the three-dimensional lace material to be used in the above-described method, as set forth in claim 8, it is preferred, in order to achieve the function/effect described in connection with claim 2 hereinbefore, that the planar lace fabric be an elastic lace fabric having elasticity in either a weft direction or warp direction of the fabric or elasticity in both these directions.

Furthermore, as set forth in claim 9, if the ornamental lace portion has a scallop-reinforcing portion at a portion in the immediate vicinity to the scallop portion, this will improve the support of the scallop portion, so that the scallop portion will appear beautifully at the edge of the cup in the finished three-dimensional lace product.

Further and other objects and advantages of the invention will become apparent upon reading the following detailed description of preferred embodiments thereof with reference to the accompanying drawings.

### BRIEF DESCRIPTION OF THE DRAWINGS

FIG. 1 is a schematic illustration showing a structure of a knitted lace fabric,

FIG. 2 is an illustration of a three-dimensional forming device,

FIG. 3 is an illustration of a three-dimensional lace material joined with an urethane cup,

FIG. 4 is a view showing a three-dimensional lace product,

FIG. 5 is an illustration showing a further embodiment of the present invention,

FIG. 6 is an illustration showing a still further embodiment of the present invention,

FIG. 7 is an exploded view showing principal components employed by the conventional method,

FIG. 8 is a view showing construction of a conventional cup product, and

FIG. 9 is an illustration showing three-dimensional forming portions according to the conventional method.

### DETAILED DESCRIPTION OF THE PREFERRED EMBODIMENTS

Preferred embodiments of the invention will be described next with reference to the accompanying drawings.

First, the structure of a planar lace fabric 1 to be manufactured by the method of the invention.

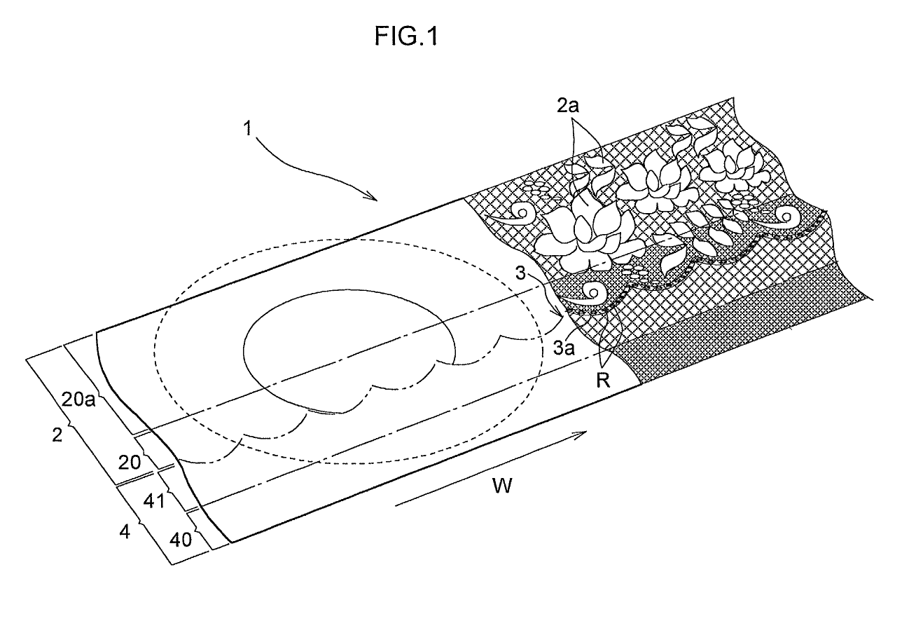

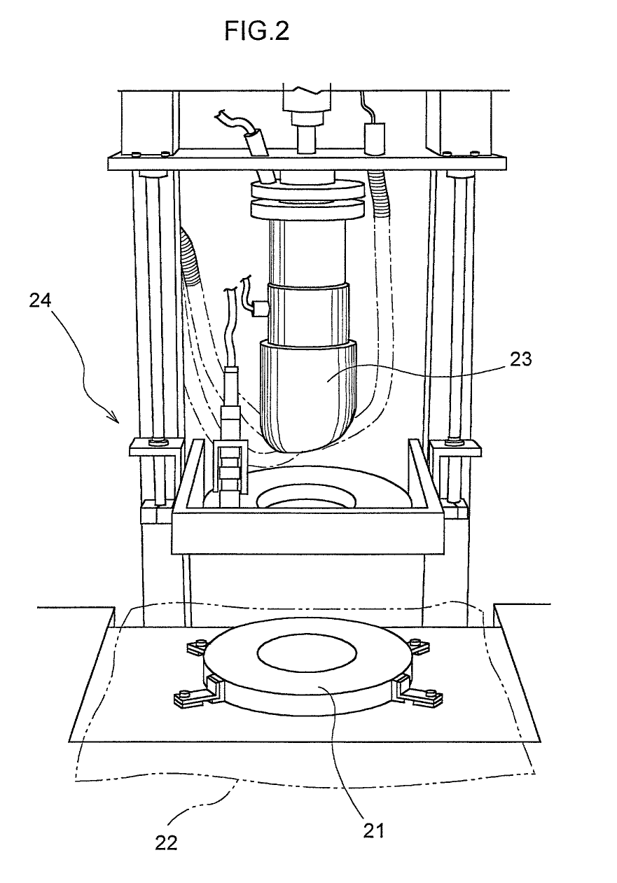

As shown in FIG. 1, a planar lace fabric 1 for forming a three-dimensional lace material relating to the invention includes an ornamental lace portion 2, a scallop portion 3 continuously adjacent the ornamental lace portion (portion adjacent the lace portion 2 in the weft direction normal to the knitting direction W of the fabric) and a waste-fabric portion 4 on the opposite side to the ornamental lace portion 2 across the scallop portion 3.

In this embodiment, the ground network of this planar lace fabric is not the more ordinary 4-course network, but a diamond-network which is well-balanced between the warp and course directions.

In the above, the ornamental lace portion 2 is a lace portion provided with a predetermined ornamental pattern. Specifically, in the case of a raschel lace for example, such lace portion may be produced by knitting onto the net, as its ground network, a number of pattern-forming yarns 2a according to a predetermined ornamental pattern.

On the other hand, the scallop portion, or simply called “scallop”, is a portion formed continuous in the wave-like form along the knitting direction W of the lace. Specifically, in the case of the raschel lace for example, this scallop portion is formed by knitting, on the net, a plurality of scallop-forming yarns 3a, a kind of pattern-forming yarn, into predetermined loops R to form an ornamental pattern, so that the number of loops R form the continuous wave-form along the knitting direction W of the lace. More particularly, a plurality of waves are formed one after another along the knitting direction W, as shown.

The waste-fabric portion 4 is basically a simple network without any pattern-forming yarns, and this portion of the fabric may be readily cut.

In this respect, it should be noted, however, that there will occur no inconvenience in the application of the present invention even if any pattern-forming yarn may be present in this waste-fabric portion or not or which the structure of this waste-fabric portion is similar to that of other ornamental pattern forming portion. Rather, what is essential here is that this waste-fabric portion can be effectively utilized for fixing the fabric to the three-dimensional forming device.

Further, as shown in FIG. 1, an end of the waste-fabric portion 4 (on the opposite side to the scallop portion 3) is constructed as a fabric-fixing portion 40, and this portion 40 uses thicker yarns and has a more dense structure than the remaining portion 41 of the waste-fabric portion.

Moreover, a portion of the ornamental lace portion 2 in the immediate vicinity of the scallop portion 3 is constructed as a scallop-reinforcing portion 20.

This scallop-reinforcing portion 20 too employs ticker yarns than the remaining ornamental lace portion 20a. So that, this portion 20 is provided with additional stiffness to effectively maintain the shape stability in the scallop portion 3. Specifically, while the remaining ornamental lace portion 20a employs polyurethane yarns of about 210 denier, the scallop-reinforcing portion 20 employs yarns of 420 denier, twice thickness.

Into the planar lace fabric 1 constructed as above, elastic yarns (not shown) are inserted along the wales of the fabric so as to provide elasticity in the warp direction of the fabric and further elastic yarns (not shown) are employed as weft yarnss (i.e. the weft yarns forming the ground network) so as to provide elasticity also in the weft direction of the fabric. In this manner, this lace fabric 1 is provided with “two-way” elasticity.

The above describes the steps for forming the planar lace fabric 1 as the preparatory steps for forming manufacturing the three-dimensional lace material 5 of the invention.

These complete a material-knitting step.

Next, there will be described a three-dimensional forming step, an eliminating step for eliminating the waste-fabric portion and a joining step for joining the fabric with an urethane cup Ca which is molded separately from the fabric.

Three-dimensional Forming Step

In this three-dimensional forming step, the planar lace fabric 1 obtained as above is formed (specifically molded) into a predetermined three-dimensional shape. This three-dimensional step is carried out by using a three-dimensional forming device 24 which includes a mold 23 for molding the fabric portion 22 and the fabric-lining portion 21 to which the fabric portion 22 is to be fixed.

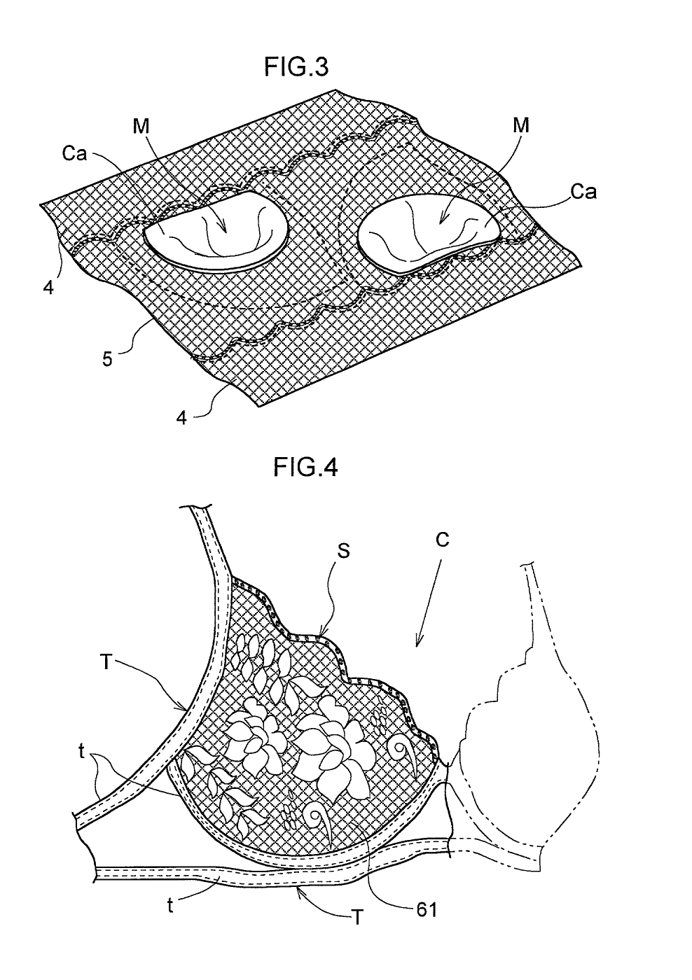

According to the method of this invention, referring to FIG. 3 for example, the three-dimensional forming step is carried out with placing the scallop portion 3 at an end of the three-dimensional shape to be formed (i.e. in the case of FIG. 3, in order to align the end of the three-dimensional shape with the end of the cup Ca, an end or edge of the cup Ca denoted with a solid line corresponds to the end of the three-dimensional shape).

For this three-dimensional forming step, in fixing the planar lace fabric 1 to the three-dimensional forming device 24, the fabric-fixing portion 40 provided in the waste-fabric portion 4 is utilized. That is, as denoted with broken lines in FIG. 1, this fabric-fixing portion 40 is utilized for the purpose of this fixing and also the peripheral edge of the fabric across the scallop portion 3 is utilized for the fixing. And, the peripheral edge (the portion or area surrounded by the solid line and the broken line in FIG. 1) of the ornamental lace portion 4 on the opposite side to the scallop portion 3 is also utilized for the fixing.

After such fixing of the planar lace fabric to the three-dimensional forming device 24, the three-dimensional forming step of the fabric is effected by means of the mold 23 and the formed three-dimensional shape is stabilized thereafter.

In the case of the present embodiment, nylon yarns 6-6 are employed as the yarns forming the fabric. Therefore, the shape stabilizing step is completed by heat-setting the yarns.

Upon completion of the three-dimensional forming step above, the three-dimensional lace material 5 obtained still is in a band-like shape having a plurality of partial projections M (projecting on the back side) as shown in FIG. 3. It is to be noted, however, this FIG. 3 shows a condition after the fabric has been joined with the urethane cup Ca.

Joining Step

In this step the three-dimensional lace material 5 having number of partial projections M obtained as above is joined with separately molded polyurethane cups Ca, respectively.

This joining step is carried out generally by means of sewing. Instead, this step may be carried out by adhesive bonding, etc.

For this joining step, the scallop portion 3 of the lace material is placed at the edge of the cup product C. With this, there may be obtained a three-dimensional lace product including the lining member Ca and the three-dimensional lace material 5 joined together with the scallop portion 3 aligned with the end of the urethane cup Ca.

Eliminating Step

Next, the band-like three-dimensional lace material obtained above is subjected to an eliminating step for eliminating the waste-fabric portion 4 along the scallop portion 3. Further, if each cup product is to be obtained independently, the peripheral edge of the cup is eliminated by cutting. The cutting line for this cutting is denoted with a broken line in FIG. 3.

With these, there is obtained a cup product including the three-dimensional ornamental lace portion 2 and the scallop portion 3 at the end (in this case, it is noted that this cup product is a single cup comprising the three-dimensional lace material and the urethane cup Ca joined together).

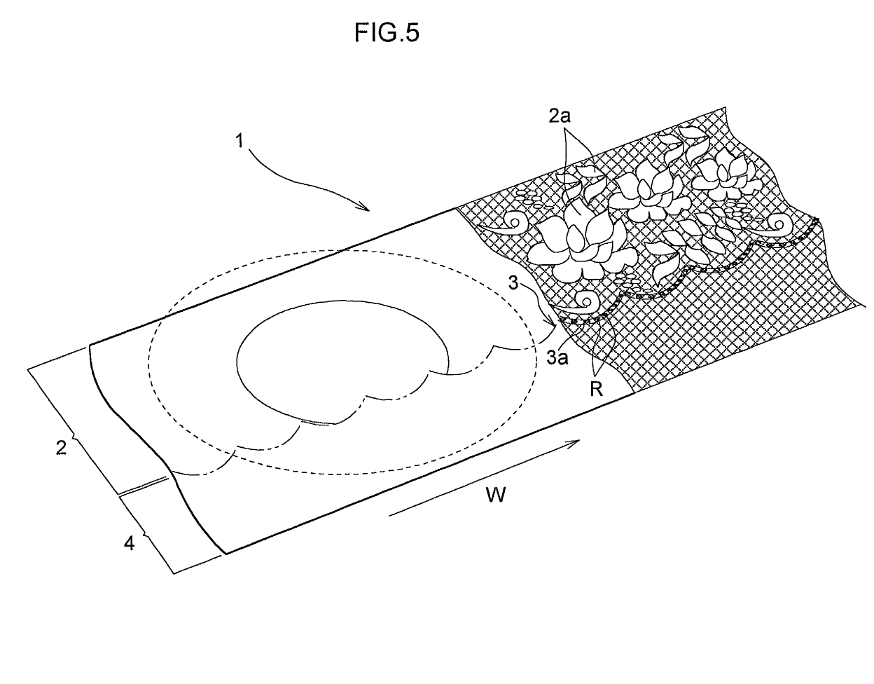

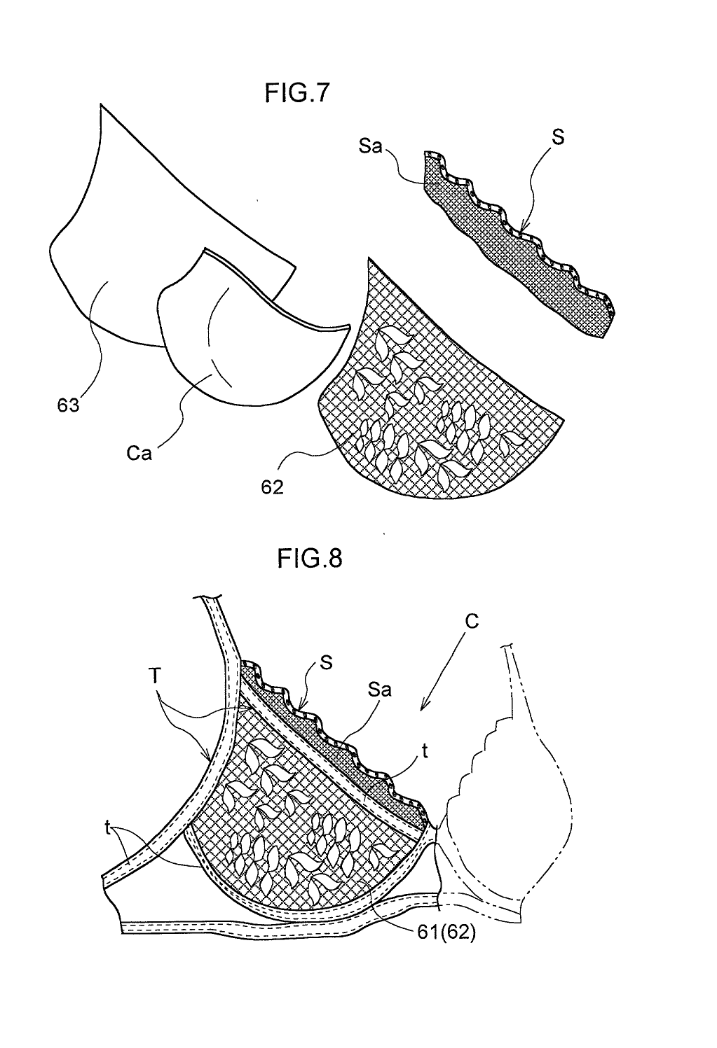

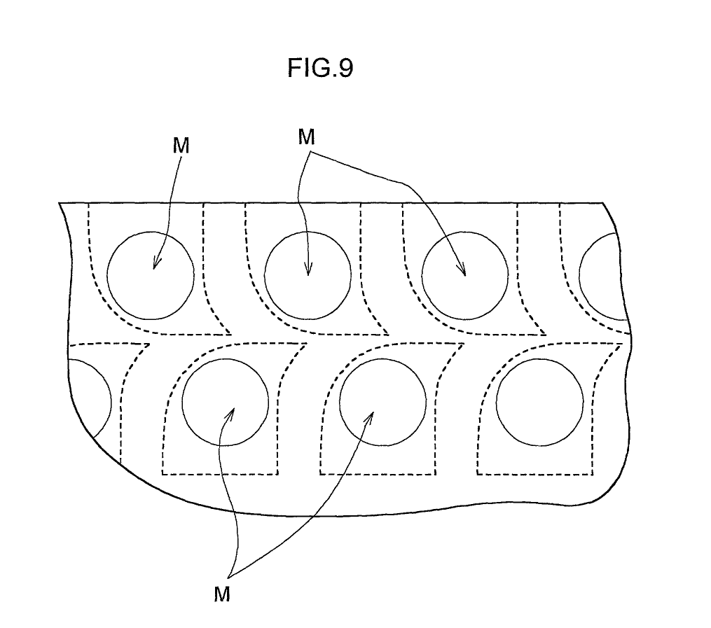

FIG. 4 shows the appearance of the cup product C obtained by the method described above. Although this corresponds to the product shown in FIG. 7, the product of FIG. 4 presents a smarter appearance due to absence of tape at the upper end of the cup because the scallop portion S is provided integrally with the front-side cloth formed of the three-dimensional lace material.

Finishing Step

Thereafter, by using the individual cup products obtained by the above in an appropriate combination, the end product, e.g. a brassier, will be obtained. This step is effected by means of sewing.

[Other Embodiments]

(a) In the foregoing embodiment, the cutting/eliminating step is carried out after the joining step of joining the band-like three-dimensional lace material (with partial projections) with the polyurethane cup Ca. Instead, it is also possible to cut the band-like three-dimensional lace material into a predetermined shape and then join it with each cup Ca.

(b) In the foregoing embodiment, the urethane cup Ca molded into a predetermined shape is employed as the lining member. Instead, this lining member may be a non-woven fabric formed or molded into a predetermined shape.

(c) In the foregoing embodiment, the fabric-fixing portion 40 is provided in the waste-fabric portion and the scallop-reinforcing portion 20 is provided at a portion of the ornamental lace portion. However, it is not necessary for the invention to provide both of these portions. Such modified construction is shown in FIG. 5 corresponding to FIG. 1.

In the absence of these portions too, the three-dimensional lace material of the invention may be obtained by appropriately selecting the types, thickness, etc. of the lace forming yarns to be employed therein.

(d) In the foregoing embodiment, there was no description about the specific type of the construction of the lace knitting machine for forming the lace material. This is because the method and material of the invention are applicable to any lace materials produced by any type of lace knitting machines. Typical examples include the raschel lace produced by the raschel knitting machine (including the falling-plate type, jacquard knitting machine), leaver lace produced by the leaver lace knitting machine, as well as embroidery lace produced by the embroidery lace knitting machine.

(e) As described hereinbefore, the waste-fabric portion may be a simple network, a network with ornamental pattern, a ground-fabric-like network etc.

In this respect, however, the this waste-fabric portion adjacent the scallop portion should be suitable for the cutting/eliminating step since this waste-fabric portion is to be eliminated by means of cutting.

(f) In the foregoing embodiment, the method and material are applied for manufacture of a brassier. However, these method and material of the invention may be applied to any other articles such as a bra-slip, bra-camisole, body-suit, shorts, etc.

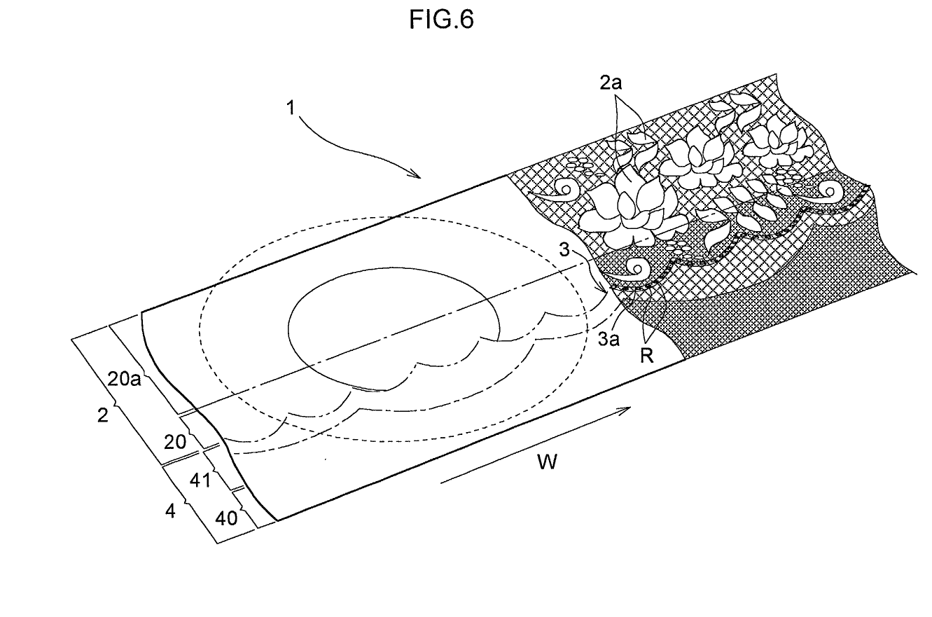

(g) In the foregoing embodiment, the fabric-fixing portion is provided with the additional strength by using yarns of different thickness or strength. Alternatively, the network of this portion may be identical to the rest of the portion, but additional insertion yarns corresponding to the ordinary pattern-forming yarns may be inserted at a predetermined are according to the predetermined shape of the fabric-fixing portion to be formed. FIG. 6 shows such modified construction, in which the border of such fabric-fixing portion is denoted with a dashed line.

The present invention may be embodied in any other manner than described above. The embodiments disclosed above are therefore not to be taken as limiting the invention, but only illustrating the invention. It is understood that such modifications and variations will be apparent to those skilled in the art without departing the scope of the invention set forth in the appended claims.

What is claimed is:

1. A method of manufacturing a three-dimensional lace material, which comprises:
a fabric-knitting step for knitting a planar lace fabric including an ornamental lace portion, a scallop portion continuously adjacent the ornamental lace portion and a waste-fabric portion on the opposite side to the ornamental lace portion across the scallop portion;
a three-dimensional forming step for forming the planar lace fabric obtained by the material-knitting step into a predetermined three-dimensional shape by setting the fabric to a three-dimensional forming device with fixing the fabric to the device at the waste-fabric portion thereof and placing the scallop portion at an end of the three-dimensional shape to be formed; and
an eliminating step for eliminating the waste-fabric portion along the scallop portion from the three-dimensional lace fabric obtained by the three-dimensional forming step, thereby to obtain the three-dimensional lace material.

2. The method according to claim 1, wherein the planar lace fabric is an elastic lace fabric having elasticity in either a weft direction or warp direction of the fabric or elasticity in both these directions.

3. The method according to claim 1 or 2, wherein the waste-fabric portion on the opposite side to the ornamental lace portion across the scallop portion includes a fabric-fixing portion to be fixed to the three-dimensional forming device, the fabric-fixing portion having a greater strength or thickness than the remaining portion of the waste-fabric portion, the remaining portion being adjacent the scallop portion.

4. The method according to claim 1 or 2, wherein the ornamental lace portion includes, at a portion thereof in the immediate vicinity of the scallop portion, a scallop-reinforcing portion.

5. The method according to claim 3, wherein the ornamental lace portion includes, at a portion thereof in the immediate vicinity of the scallop portion, a scallop-reinforcing portion.

6. A method of manufacturing a three-dimensional lace product, which comprises:
a joining step for joining a lining member to the three-dimensional lace material according to any one of claims 1-5 to obtain a three-dimensional lace product, with aligning the scallop portion with an end of the lining member.

7. A planar lace fabric for forming a three-dimensional lace material comprising an ornamental lace portion, a scallop portion continuously adjacent the ornamental lace portion and a waste-fabric portion on the opposite side to the ornamental lace portion across the scallop portion, the waste-fabric portion including a fabric-fixing portion having a greater strength or thickness than the remaining portion of the waste-fabric portion, the remaining portion being adjacent the scallop portion.

8. The planar lace fabric for forming a three-dimensional lace material according to claim 7, wherein the planar lace fabric is an elastic lace fabric having elasticity in either a weft direction or warp direction of the fabric or elasticity in both these directions.

9. The planar lace fabric for forming a three-dimensional lace material according to claim 7 or 8, wherein the ornamental lace portion has a scallop-reinforcing portion at a portion in the immediate vicinity to the scallop portion.
